(19) United States
(12) Patent Application Publication
(10) Pub. No.: US 2026/0288559 A1
(43) Pub. Date: Sep. 24, 2026

(54) SYSTEM AND METHOD FOR ADAPTIVE ANOMALY DETECTION IN DATA USING LEARN-ABLE LOSS FUNCTIONS

(71) Applicant: RAPTORXAI PRIVATE LIMITED, Tellapur (IN)

(72) Inventors: Pratyusha Vemuri Venkata, Tellapur (IN); Zhongyuan Wang, Hangzhou (CN)

(21) Appl. No.: 19/570,102

(22) Filed: Mar. 17, 2026

(30) Foreign Application Priority Data
Mar. 19, 2025 (IN) 202541024623

(51) Int. Cl. G06F 11/07; G06N 3/0455; G06N 3/08

(52) U.S. Cl. CPC G06F 11/0751; G06F 11/0715; G06F 11/0793; G06N 3/0455; G06N 3/08

(57) ABSTRACT

The present invention provides an adaptive anomaly detection system using learn-able loss functions. integrating an autoencoder neural network and a dynamic loss weighting module to improve anomaly classification accuracy and real-time adaptability. The data processing unit collects, normalizes, and transforms input data before feeding it into the autoencoder neural network, which generates a latent representation, reconstructs input data, and computes reconstruction errors. The dynamic loss weighting module assigns adaptive weights to reconstruction errors, dynamically adjusting anomaly sensitivity and determining an optimal threshold via an iterative learning process. An adaptive training module optimizes the system using backpropagation while dynamically updating hyperparameters. A deployment module integrates the trained system into real-time applications.

### FIELD OF THE INVENTION

The present invention relates to the field of anomaly detection and machine learning-based data analysis. Specifically, it involves an adaptive anomaly detection system using learn-able loss functions to improve anomaly classification accuracy. The invention is applicable in cybersecurity, financial fraud detection, industrial monitoring, and healthcare diagnostics, enabling real-time, self-learning anomaly detection with enhanced adaptability and precision.

### BACKGROUND OF THE INVENTION

Anomaly detection is a critical component in various technological fields, including cybersecurity, fraud detection, system monitoring, and quality control. It involves identifying patterns or instances that deviate significantly from expected behavior within datasets. Traditional anomaly detection techniques rely on statistical models or rule-based systems that require manual configuration and domain expertise. These conventional approaches often lack adaptability and struggle to handle complex, evolving data distributions, making them inefficient in dynamic environments.

In recent years, machine learning-based anomaly detection methods, particularly autoencoder neural networks, have gained prominence as powerful tools for unsupervised anomaly detection. Autoencoders compress and reconstruct input data, assuming that anomalous instances will exhibit higher reconstruction errors compared to normal samples. However, existing autoencoder-based solutions suffer from multiple limitations that hinder their effectiveness.

One of the key challenges is the limitation of conventional loss functions used in training autoencoders. These loss functions treat all reconstruction errors uniformly, failing to differentiate between normal variations and actual anomalies. This uniform treatment reduces model efficiency, particularly in cases involving imbalanced datasets or complex anomaly patterns. Without distinguishing between minor fluctuations and meaningful deviations, the model may struggle to correctly classify anomalous instances.

Another major drawback of current anomaly detection systems is their dependency on manual threshold tuning for anomaly classification. Many systems require predefined anomaly thresholds, which must be manually set and adjusted based on dataset characteristics. This process is time-consuming, labor-intensive, and highly dataset-specific, reducing the system's ability to generalize across different domains. Moreover, manually defined thresholds may fail to adapt to evolving data trends, leading to reduced detection accuracy over time.

Additionally, existing solutions often face difficulties in balancing anomaly sensitivity and robustness against false positives. If an anomaly detection system is too sensitive, it may generate excessive false alarms, leading to unnecessary interventions and operational inefficiencies. Conversely, if the system is too conservative, it risks missing critical anomalies, which can result in security breaches, financial losses, or equipment failures. The lack of a dynamic, self-adjusting mechanism further limits the practical applicability of traditional approaches.

Furthermore, current anomaly detection models lack mechanisms for automatically adjusting their detection criteria based on changing data characteristics. In real-world applications, anomaly patterns evolve over time, requiring adaptive models that can learn from new data trends without manual reconfiguration. The absence of such adaptability restricts the effectiveness of traditional models in high-speed, large-scale environments where real-time anomaly detection is crucial. So, there exists a need to develop a system that is capable of eliminating drawbacks of the prior arts.

### SUMMARY OF THE INVENTION

In view of the foregoing disadvantages inherent in the prior art, the general purpose of the present disclosure is to provide a system and method for adaptive anomaly detection in data to include all advantages of the prior art, and to overcome the drawbacks inherent in the prior art.

Some of the objects of the present disclosure, which at least one embodiment herein satisfies, are as follows:

An object of the present disclosure is to ameliorate one or more problems of the prior art or to at least provide a useful alternative. An object of the present disclosure is to provide a system for adaptive anomaly detection in data using learn-able loss functions.

Another object of the present disclosure is to provide a method for adaptive anomaly detection in data using learn-able loss functions.

Another object of the present disclosure is to provide a system that automates anomaly classification by dynamically adjusting sensitivity based on statistical deviations, eliminating the need for manual threshold tuning.

Another object of the present disclosure is to provide a system that continuously refines anomaly detection accuracy through iterative optimization, allowing the system to adapt to evolving data distributions across different domains.

Another object of the present disclosure is to provide a system that enhance anomaly detection precision by intelligently differentiating between normal variations and actual anomalies, reducing false positives while maintaining high sensitivity to critical anomalies.

Still another object of the present disclosure is to provide a system that enable real-time processing and scalability by integrating the detection framework with high-volume data streams, ensuring efficient operation in large-scale applications such as cybersecurity, fraud detection, industrial monitoring, and healthcare diagnostics.

Other objects and advantages of the present disclosure will be more apparent from the following description, which is not intended to limit the scope of the present disclosure.

The system for adaptive anomaly detection in data using learn-able loss functions comprises a data processing unit, an autoencoder neural network, a dynamic loss weighting module, an adaptive training module, and a deployment module. The data processing unit is responsible for collecting, normalizing, and transforming input data received from one or more sources, ensuring consistency and improving model accuracy. Additionally, the data processing unit further removes outliers and extracts relevant features, thereby improving the quality of data before processing.

The autoencoder neural network, generates a latent representation of the transformed data, reconstructs the input data, and computes reconstruction errors, which are analyzed to detect anomalies. Unlike conventional models, the autoencoder neural network in the present invention utilizes multiple activation functions, such as ReLU, sigmoid, or tanh, as described in claim 3, to improve training efficiency and performance across different datasets.

The dynamic loss weighting module, which assigns adaptive weights to reconstruction errors based on statistical deviation from normal patterns. This module applies a weighted loss function that prioritizes high-impact anomalies while suppressing minor deviations, ensuring that meaningful anomalies receive more attention while reducing false positives. Additionally, the dynamic loss weighting module automatically determines an anomaly threshold based on an iterative learning process, eliminating the need for manual threshold adjustments.

The adaptive training module (140), plays a crucial role in optimizing the anomaly detection process. It dynamically updates hyperparameters, such as learning rate, batch size, and regularization coefficients, using backpropagation and gradient-based optimization techniques. This self-learning mechanism allows the system to continuously refine its detection capabilities based on newly encountered anomalies, ensuring adaptability across different real-world applications.

The deployment module, enables the integration of the anomaly detection system with real-time data processing frameworks. It provides an API-based interface for external monitoring systems, allowing seamless implementation in cybersecurity, fraud detection, industrial monitoring, and healthcare diagnostics. The system can be deployed in cloud environments, edge computing systems, or enterprise networks, ensuring scalability and real-time responsiveness.

In an aspect of the present disclosure, a method for detecting anomalies using learn-able loss functions, follows a structured approach where input data is received, preprocessed, analyzed using an autoencoder neural network, and classified using the dynamic loss weighting module. The adaptive training module (140) continuously optimizes the system, and the trained anomaly detection model is deployed in real-time applications. As described in claim 8, the preprocessing step includes detecting missing data, normalizing values across multiple sources, and filtering irrelevant features, improving data quality before analysis.

### BRIEF DESCRIPTION OF DRAWINGS

The foregoing summary, as well as the following detailed description of various embodiments, is better understood when read in conjunction with the drawings provided herein. For the purposes of illustration, there are shown in the drawings exemplary embodiments; however, the presently disclosed subject matter is not limited to the specific methods and instrumentalities disclosed.

FIG. 1 illustrates a block diagram of the system for adaptive anomaly detection in data as disclosed in the present disclosure;

FIG. 2 illustrates a flow chart depicting working of the system for adaptive anomaly detection in data as disclosed in the present disclosure;

FIG. 3 illustrates the internal structure of autoencoder neural network of the system for adaptive anomaly detection in data as disclosed in the present disclosure; and

FIG. 4 illustrates the training process of the system for adaptive anomaly detection in data as disclosed in the present disclosure;

Like reference numerals refer to like parts throughout the description of several views of the drawing.

### DETAILED DESCRIPTION OF THE INVENTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open-ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The following detailed description should be read with reference to the drawings, in which similar elements in different drawings are identified with the same reference numbers. The drawings, which are not necessarily to scale, depict illustrative embodiments and are not intended to limit the scope of the disclosure.

It is to be understood that both the foregoing general description and the following detailed description are exemplary and explanatory only and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

Furthermore, the term “module”, as used herein, refers to logic embodied in hardware or firmware, or to a collection of software instructions, written in a programming language, such as, Java, C, C++, python, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

The present invention relates to an adaptive anomaly detection system that employs a dynamic loss weighting mechanism within an autoencoder-based neural network (120) to enhance anomaly sensitivity, optimize detection accuracy, and provide real-time adaptability.

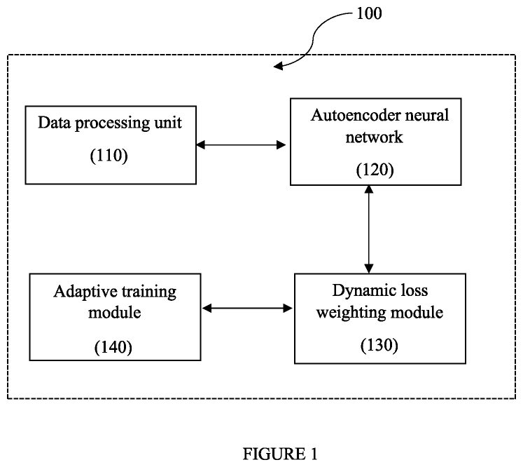

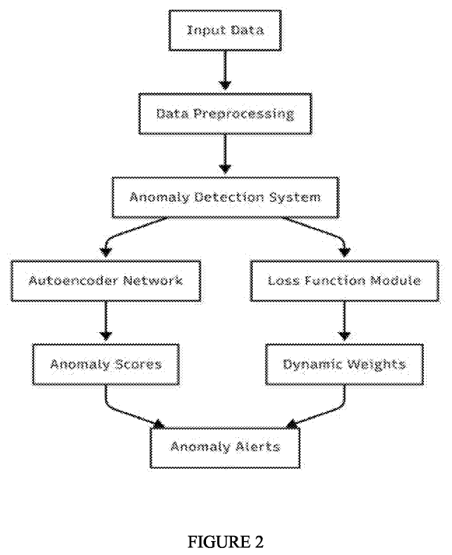

As illustrated in FIGS. 1 and 2, the system (100) for anomaly detection in data comprises a data processing unit (110), an autoencoder neural network (120), a dynamic loss weighting module (130), an adaptive training module (140), and a deployment module. The data processing unit (110) is responsible for collecting, normalizing, and transforming input data from one or more sources. The one or more sources include but not limited to multiple sources, including network traffic logs, industrial IoT devices, financial transactions, and healthcare diagnostics systems. The data processing unit (110) further removes outliers and extracts relevant features before processing the input data. Before transmitting the data to an autoencoder neural network (120) coupled with the data processing unit (110), the data processing unit (110) performs several preprocessing tasks, such as removing noise, detecting and handling missing values, standardizing input features, and applying transformation techniques to ensure data consistency. This preprocessing step ensures that the input data is structured, noise-free, and suitable for effective anomaly detection. The autoencoder neural network (120) utilizes plurality of activation functions selected from ReLU, sigmoid, or tanh to enhance training efficiency.

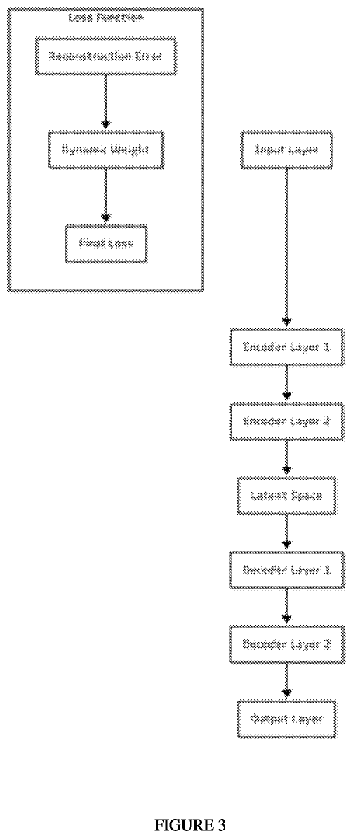

As illustrated in the FIG. 3, the autoencoder neural network (120), coupled with the data processing unit (110), learns the underlying data structure, reconstruct the input data, and compute reconstruction errors. The autoencoder consists of two main components that are an encoder and a decoder. The encoder compresses the preprocessed data into a lower-dimensional latent representation, capturing key features and eliminating redundant information. The decoder attempts to reconstruct the original input data from this latent representation, generating an approximation of the initial data. The difference between the input data and the reconstructed data, measured as a reconstruction error, serves as an essential indicator of anomalies. A higher reconstruction error implies a deviation from normal patterns, making the data point more likely to be anomalous.

Further, to enhance the effectiveness of anomaly classification, the system (100) incorporates a dynamic loss weighting module (130), which assigns adaptive weights to the reconstruction errors based on their statistical deviation from normal patterns. The dynamic loss weighting module (130) ensures that anomaly sensitivity is continuously adjusted in real-time. The module modifies loss contributions during training to prioritize high-impact anomalies while suppressing minor deviations that could lead to false positives. Additionally, the dynamic loss weighting module (130) determines an optimal anomaly threshold through an iterative learning process, eliminating the need for manual threshold tuning. The dynamic loss weighting module (130) ensures that the system (100) remains highly adaptable to evolving data distributions, making it suitable for deployment in dynamic environments.

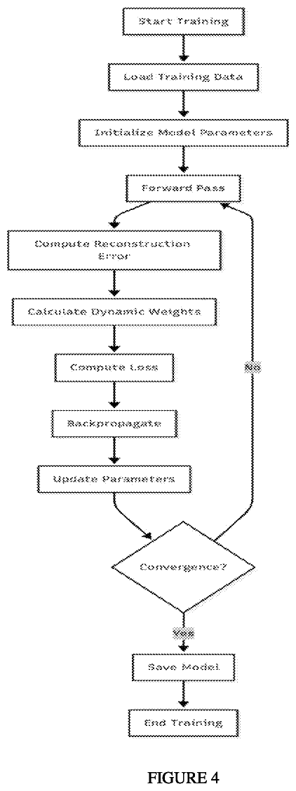

In an embodiment of the present disclosure, as illustrated in the FIG. 4, the adaptive training module (140), coupled with the dynamic loss weighting module (130), plays a crucial role in optimizing the performance of the anomaly detection system (100). The adaptive training module (140) iteratively updates the parameters of the autoencoder neural network (120) and the dynamic loss weighting module (130) using backpropagation and gradient-based optimization techniques. These parameters include the weights and biases of the autoencoder's encoder and decoder layers, the latent space representation that influences data compression, and the loss function parameters that dynamically adjust anomaly sensitivity. Additionally, the adaptive training module (140) fine-tunes hyperparameters such as the learning rate, batch size, and regularization coefficients to optimize model convergence and prevent overfitting. By dynamically adjusting these hyperparameters in response to detected anomalies, the system (100) continuously improves its detection accuracy without requiring manual intervention. This self-learning capability ensures that the model adapts efficiently to evolving data patterns, making it highly scalable and effective for large-scale applications across cybersecurity, fraud detection, industrial monitoring, and healthcare diagnostics.

In addition, the dynamic loss weighting module (130) incorporates learnable loss function to achieve this adaptive weighting mechanism. The learnable loss function operates by computing the reconstruction error for each data point processed by the autoencoder neural network. Instead of treating all reconstruction errors equally, the function assigns higher loss weights to errors that deviate significantly from normal patterns while suppressing minor fluctuations. This is achieved using a sigmoid-based adaptive weighting mechanism, which enables a smooth transition between normal and anomalous weight assignments. As defined in claim 1, the dynamic loss weighting module automatically determines the anomaly threshold using an iterative learning process, eliminating the need for manual threshold tuning.

Moreover, the learnable loss function achieve this adaptive weighting mechanism by the following steps. First, a base weight (Wₙₒᵣₘₐₗ) is applied to data samples with reconstruction errors that fall within the expected range of normal data distributions. This ensures that normal data points do not excessively influence the model's training process. Next, a learnable parameter (b) is introduced to determine the maximum weight assigned to anomalous samples, ensuring that significant deviations are prioritized for classification. Unlike conventional fixed-threshold models, this learnable parameter is continuously optimized during training, improving the model's ability to differentiate between minor deviations and genuine anomalies.

To enable a smooth transition between normal and anomalous weight assignments, the loss function incorporates a sigmoid function (a), which gradually adjusts the weighting instead of applying abrupt thresholding. This eliminates sharp decision boundaries, reducing misclassification errors that typically arise from fixed-threshold approaches. Additionally, a scale parameter controls the sharpness of this transition, allowing the system (100) to fine-tune the sensitivity of anomaly classification dynamically. The threshold parameter further defines the boundary between normal and anomalous reconstruction errors, ensuring that high-impact anomalies receive greater emphasis during training.

The weight assigned to each sample is computed according to the following formula:

$$w = {w}_{normal} + ( softplus ( b ) - {w}_{normal} ) \cdot σ ( scale \cdot ( MSE - threshold ) )$$

where:
σ represents the sigmoid function
softplus ensures the positivity of the anomaly weight
MSE is the mean squared reconstruction error

By integrating this learnable loss function into the dynamic loss weighting module (130), the system (100) eliminates the need for manually defined anomaly thresholds, significantly improving detection accuracy and adaptability. The function continuously refines itself as the model encounters new data, enabling real-time updates to anomaly classification sensitivity. This approach not only improves generalization across diverse datasets but also ensures that the system (100) remains resilient to evolving anomaly patterns, making it highly suitable for real-world applications such as cybersecurity, financial fraud detection, industrial monitoring, and healthcare diagnostics.

Moreover, the deployment module is coupled with the adaptive training module (140), for integrating the trained anomaly detection system (100) with real-time data processing frameworks, allowing seamless application across various industries. The deployment module provides an API-based interface that enables external monitoring systems to interact with the anomaly detection model, facilitating smooth integration into existing cybersecurity, financial fraud detection, industrial monitoring, and healthcare diagnostic systems. Additionally, the deployment module enables edge computing and cloud-based deployment, making it versatile for real-world applications. The system (100) supports real-time decision-making, automatically triggering alerts when an anomaly score crosses a confidence threshold, allowing immediate action to be taken in critical scenarios.

In an aspect of the present disclosure, the method for anomaly detection involves a multi-step process designed to ensure accurate and efficient classification of anomalies. The process begins with receiving input data from multiple sources, which is then processed through the data processing unit (110) for normalization, feature extraction, and transformation. The autoencoder neural network (120) encodes the processed data into a latent representation, reconstructs the input data, and computes reconstruction errors to identify deviations from expected patterns. The dynamic loss weighting module (130) is applied to assign adaptive weights to reconstruction errors, ensuring that high-impact anomalies receive greater emphasis while minor deviations are suppressed. The anomaly threshold is determined dynamically, eliminating the need for manually defined cutoff values. The adaptive training module (140) continuously optimizes the autoencoder neural network (120) and the dynamic loss weighting module (130) using backpropagation, refining model accuracy based on real-time feedback. Finally, the trained anomaly detection system (100) is deployed in real-time applications, integrating with cybersecurity frameworks, fraud detection platforms, industrial monitoring solutions, and healthcare diagnostic tools, anomaly detection step generates an anomaly score for each data point based on a weighted reconstruction error and applies a confidence threshold to refine anomaly classification.

In an exemplary embodiment of the present disclosure, the system (100) can be deployed across various industries to enhance anomaly detection capabilities. In cybersecurity, the system (100) can identify network intrusions, detect malware activities, and flag unauthorized access attempts in real time. In financial fraud detection, the system (100) can analyze transaction patterns, detect fraudulent activities, and prevent unauthorized payments. In industrial monitoring, the system (100) can predict machine failures, identify faulty sensor readings, and optimize operational efficiency. In healthcare diagnostics, the system (100) can detect abnormalities in medical imaging, monitor patient health records, and provide early detection of critical diseases.

In another exemplary embodiment of the present disclosure, to evaluate the effectiveness of the proposed adaptive anomaly detection system (100), a series of experiments were conducted using the KDD Cup 1999 dataset, a widely recognized benchmark for anomaly detection. The experiments were designed to assess the system's ability to accurately identify anomalies by analyzing reconstruction error patterns and latent space clustering quality. Unlike conventional methods that rely on static thresholds and predefined statistical models, the present invention integrates a learnable loss function within the dynamic loss weighting module (130), enabling the system (100) to adjust its anomaly detection sensitivity in real-time.

The evaluation framework focused on two critical aspects: reconstruction error assessment and latent space clustering quality. Reconstruction error assessment measures how well the autoencoder neural network (120) differentiates between normal and anomalous data based on the discrepancy between input and reconstructed data. Latent space clustering quality evaluates how well the autoencoder organizes data in its learned feature space, ensuring that normal and anomalous data points form distinct clusters. A higher clustering quality indicates that the model is better at separating anomalous instances from normal patterns, leading to more accurate classification.

To provide a comprehensive analysis, the system's (100) performance was measured using two key metrics: Normalized Mutual Information (NMI) and Adjusted Rand Index (ARI). NMI quantifies the similarity between the predicted and actual clusters, evaluating how well the model organizes data in the latent space. A higher NMI score indicates that the system (100) effectively separates normal and anomalous data points. ARI measures the alignment between predicted anomaly labels and ground-truth labels, providing an objective measure of classification accuracy. A higher ARI score confirms that the model correctly groups anomalies while minimizing misclassifications.

The experimental results, as presented in the given Table, demonstrate the superior performance of the Loss-Aware Autoencoder (LAA) compared to baseline autoencoder models, including the Standard Autoencoder and Variational Autoencoder (VAE). The Loss-Aware Autoencoder, which integrates the dynamic loss weighting module (130) and the learnable loss function, achieved the highest NMI score (0.8255) and the best ARI score (0.9185), outperforming both baseline models. These results validate that the proposed system (100) enhances anomaly clustering and improves anomaly classification accuracy.

| Model Configuration | NMI Score | ARI Score |
|---|---|---|
| Standard Autoencoder | 0.8045 | 0.9052 |
| Variational Autoencoder (VAE) | 0.8032 | 0.9062 |
| Loss-Aware Autoencoder (LAA) | 0.8255 | 0.9185 |

A detailed analysis of the results shows that the Loss-Aware Autoencoder provides significant improvements in both latent space representation and anomaly classification performance. The higher NMI score (0.8255) confirms that the model generates well-separated clusters, making it easier to distinguish between normal and anomalous instances. Similarly, the best ARI score (0.9185) indicates that the proposed system (100) successfully aligns its predictions with actual anomaly labels, outperforming traditional autoencoder-based approaches.

Further analysis reveals that the learnable loss function plays a crucial role in improving anomaly detection accuracy. By dynamically assigning weights to reconstruction errors, the system (100) prioritizes high-impact anomalies while suppressing insignificant variations, reducing the risk of false positives and false negatives. Unlike traditional models that rely on static loss functions, the Loss-Aware Autoencoder continuously updates its loss weighting parameters during training, allowing the system (100) to self-adapt to changing data distributions. This capability is particularly valuable in real-world applications where anomaly characteristics evolve over time, such as cybersecurity, fraud detection, industrial monitoring, and healthcare diagnostics.

The Loss-Aware Autoencoder (LAA) outperformed both the Standard Autoencoder and the Variational Autoencoder (VAE) across all evaluation metrics, demonstrating its superior ability to detect anomalies in diverse data environments. The key findings from the performance analysis are:
Highest NMI Score (0.8255): The improved clustering quality in latent space ensures better organization of normal and anomalous data points, leading to more precise anomaly detection.
Best ARI Score (0.9185): The system's enhanced ability to align anomaly labels with actual classifications significantly reduces misclassification errors.
Superior Reconstruction Error Handling: The learnable loss function effectively adjusts loss weight assignments, enabling the system (100) to detect anomalies that would otherwise be misclassified by static-threshold models.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

While the invention has been described in connection with what is presently considered to be the most practical and various embodiments, it is to be understood that the invention is not to be limited to the disclosed embodiments, but on the contrary, is intended to cover various modifications and equivalent arrangements.

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. A system for adaptive anomaly detection using learn-able loss functions, comprising:
a data processing unit, to collect, normalize, and transform an input data received from one or more sources;
an autoencoder neural network, coupled to the data processing unit, to generate a latent representation of the transformed data, reconstruct the input data, compute reconstruction errors, and analyze the reconstruction errors for anomaly detection; and
a dynamic loss weighting module, coupled to the autoencoder neural network, configured to:
assign adaptive weights to the reconstruction errors based on statistical deviation from normal patterns;
adjust anomaly sensitivity dynamically by modifying loss contributions during training; and
determine an anomaly threshold automatically based on an iterative learning process;
an adaptive training module, coupled to the dynamic loss weighting module, configured to:
optimize the autoencoder neural network and the dynamic loss weighting module using backpropagation; and
continuously refine anomaly detection sensitivity based on detected anomalies.

2. The system as claimed in claim 1, wherein the data processing unit further removes outliers and extracts relevant features before processing the input data.

3. The system as claimed claim 1, wherein the autoencoder neural network utilizes plurality of activation functions selected from ReLU, sigmoid, or tanh to enhance training efficiency.

4. The system as claimed claim 1, wherein the dynamic loss weighting module applies a weighted loss function that prioritizes high-impact anomalies while suppressing minor deviations.

5. The system as claimed claim 1, wherein the adaptive training module dynamically updates hyperparameters including learning rate, batch size, and regularization coefficients during backpropagation.

6. The system as claimed claim 1, further comprises a deployment module integrates the anomaly detection system with real-time data processing frameworks and provides an API-based interface for external monitoring systems.

7. A method for detecting anomalies in data using learn-able loss functions, comprising:
receiving an input data from one or more sources;
processing the input data via a data processing unit, wherein the input data is normalized and transformed;
generating a latent representation of the processed data, reconstructing the input data, computing reconstruction errors, and analyzing the reconstruction errors for anomaly detection, via an autoencoder neural network;
applying a dynamic loss weighting module, wherein:
adaptive weights are assigned to the reconstruction errors based on statistical deviation from normal patterns;
anomaly sensitivity is adjusted dynamically by modifying loss contributions during training;
an anomaly threshold is determined automatically based on an iterative learning process;
optimizing the autoencoder neural network and the dynamic loss weighting module via an adaptive training module, wherein backpropagation is applied to refine anomaly detection sensitivity based on detected anomalies; and
deploying the trained anomaly detection via a deployment module, integrated with real-time applications including cybersecurity, fraud detection, industrial monitoring, and healthcare diagnostics.

8. The method as claimed in claim 7, wherein the processing step includes detecting missing data, normalizing input values across multiple sources, and filtering irrelevant features.

9. The method as claimed in claim 7, wherein the anomaly detection step generates an anomaly score for each data point based on a weighted reconstruction error and applies a confidence threshold to refine anomaly classification.

10. The method as claimed in claim 7, wherein the trained anomaly detection system is deployed in cybersecurity for intrusion detection, financial fraud monitoring, industrial fault prediction, and medical diagnostics for early disease detection.
